(19) United States
(12) Patent Application Publication
(10) Pub. No.: US 2015/0278767 A1
(43) Pub. Date: Oct. 1, 2015

(54) Taste of Theater App

(71) Applicants: Victor Lenell Gulley, Chicago, IL (US); Regina Monita High, Park Forest, IL (US)

(72) Inventors: Victor Lennell Gulley, Chicago, IL (US); Regina Monita High, Park Forest, IL (US)

(21) Appl. No.: 14/638,423

(22) Filed: Mar. 4, 2015

(51) Int. Cl. G06Q 10/10; G06Q 30/02; G06Q 50/00; G06Q 30/06

(52) U.S. Cl. CPC G06Q 10/1053; G06Q 30/0645; G06Q 30/0277; G06Q 50/01

(57) ABSTRACT

A Taste Of Theater App is tangibly stored Computer software that allows the theatre goer to locate live theatre, watch a preview and purchase a ticket to it. It allows the playwright to manage the administrative theatrical process. It also allows actors to manage and get credit for past productions. It gives the venue owner the ability to streamline or manage the rental of the space they own.

### BACKGROUND OF THE INVENTION

Prior to the creation of our software people had to go to specific websites for each city or area to find plays. For example, Ticketmaster® allows people to buy a ticket for a play but only for Broadway or Ticketmaster venue. There are 15 or more similar such ticketing software applications available for plays. Unlike such ticketing software applications, the embodiments herein do not handle tickets but instead allow these programs to work through software as described herein by example. Reviews have been only given on sites like yelp® or Angie's list® but they handle all subjects and all industries as we handle all things theatre only. There are sites that are dedicated just for auditions but you still have to go to the audition. Embodiments of the software described herein allows you to apply for the audition and book the appointment.

### BRIEF SUMMARY OF THE INVENTION

One particular embodiment of the invention is a one stop shop for playwrights to find actors, venues and theater goers. For example, such an embodiment allows playwrights to manage the process of doing a play, and also allows actors to manage their careers by utilizing one place to find auditions and their schedules as well as allowing venue owners to rent their facility easier and more efficient for plays to be performed at that location. The described embodiments also allows theater goers to easily find and attend plays in their area. The art described in the drawings of the design and utility function illustrate the unique ability and functions of the invention. The described embodiments of the “A Taste Of Theater App” is also a one stop shop for playwrights to find actors, venue's and theater goers.

### BRIEF DESCRIPTION OF THE SEVERAL VIEWS OF THE DRAWINGS

There are 35 drawings in total that describe and illustrate the design and function of certain embodiments of these teachings.

FIG. 1: is the Log in screen for a playwright

FIG. 2: is the Profile screen for a playwright

FIG. 3: is the modification of a playwrights profile

FIG. 4: is the Addition of a play for a playwright

FIG. 5: is the list of the playwright's catalog of plays.

FIG. 6: is the modification of a playwrights play.

FIG. 7: is the list of Personnel or Actors staring in the playwrights play.

FIG. 8: is the list and creation of a rehearsal schedule for a playwrights play.

FIG. 9: is the actual rehearsal schedule a playwright created for personnel.

FIG. 10: is the list and creation of an audition schedule for a playwrights play.

FIG. 11: are the fields required to create an audition schedule for a playwrights play.

FIG. 12: is the result a playwright gets when actors have applied for an audition.

FIG. 13: Is the query for a venue for a playwright to have his play at.

FIG. 14: Is the result a query for a venue.

FIG. 15: Is the query for an actor to star in your play.

FIG. 16: Is the results of a query for a potential actors to star in your play.

FIG. 17: Is the actors profile and history of plays he or she has been in.

FIG. 18: Is the log in screen for an actor.

FIG. 19: is the profile of the registered actor.

FIG. 20: is the actor's ability to modify his or her profile.

FIG. 21: is the actor's ability to add any plays that he or she was in that is currently not listed.

FIG. 22: is the actors query for possible auditions.

FIG. 23: is the actor's calendar showing current appointments.

FIG. 24: is the log in screen for a venue owner.

FIG. 25: is the profile screen for a venue owner.

FIG. 26: allows the venue owner to add the details and cost of a venue.

FIG. 27: allows the venue owner to make changes to his or her profile.

FIG. 28: is the catalog of all of the owner's venues

FIG. 29: is the venue owner's calendar of events.

FIG. 30: is the theater goers search for a play by zip code.

FIG. 31: is the result of plays available in that zip code.

FIG. 32: are the details of the play in that zipcode including where, when and what it is about.

FIG. 33: are the details of the play in that zipcode including the actors who are in the show.

FIG. 34: are the details of the play in that zipcode include the day and time of the show.

FIG. 35: are the details of the play in that zipcode including the ticket cost and ability to purchase.

### DETAILED DESCRIPTION OF THE PREFERRED EMBODIMENT

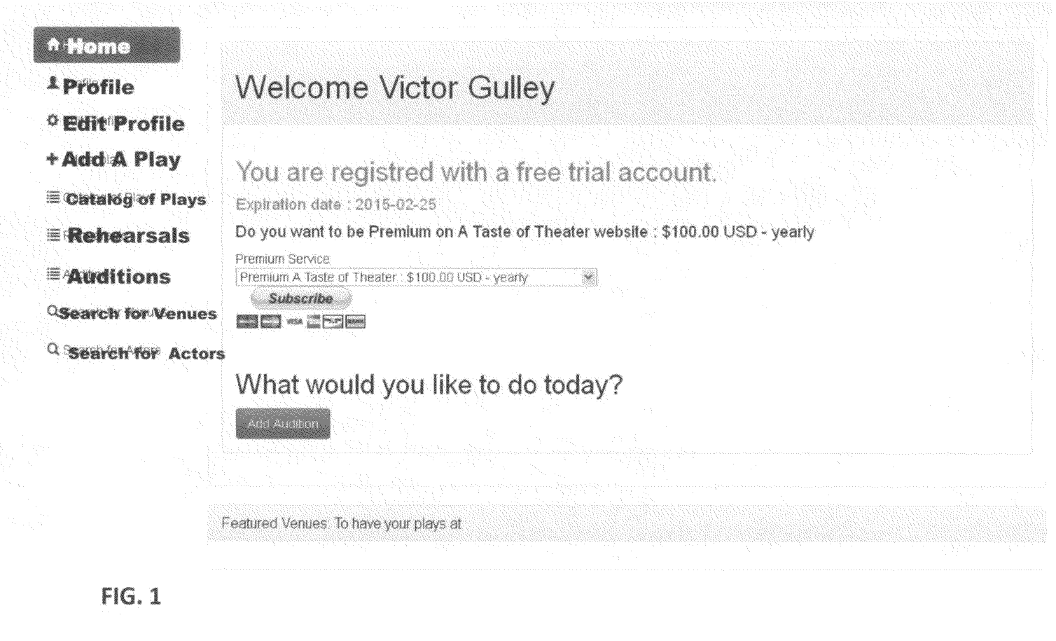

FIG. 1: In illustration is the Log in screen for a playwright

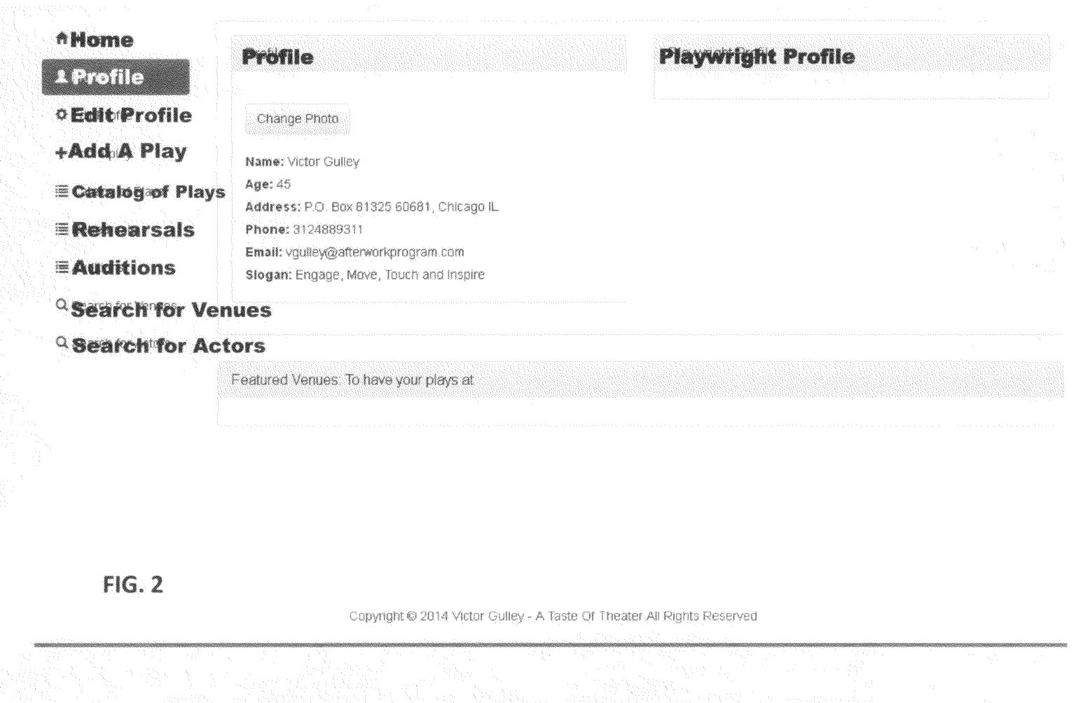

FIG. 2: In illustration is the Profile screen for a playwright

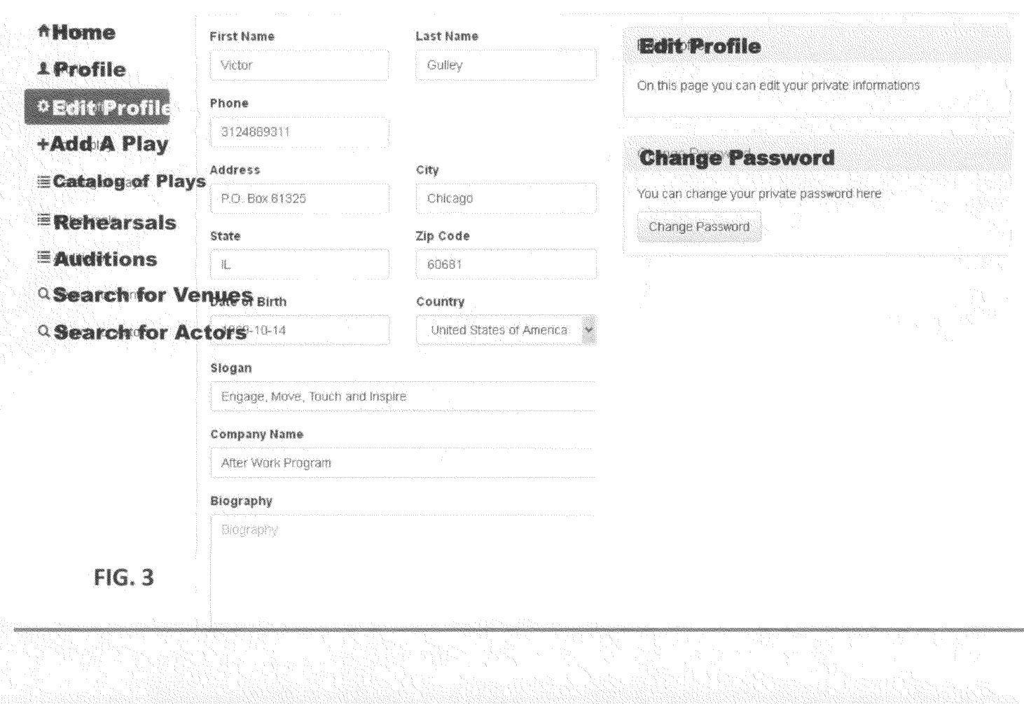

FIG. 3: In illustration is the modification of a playwrights profile

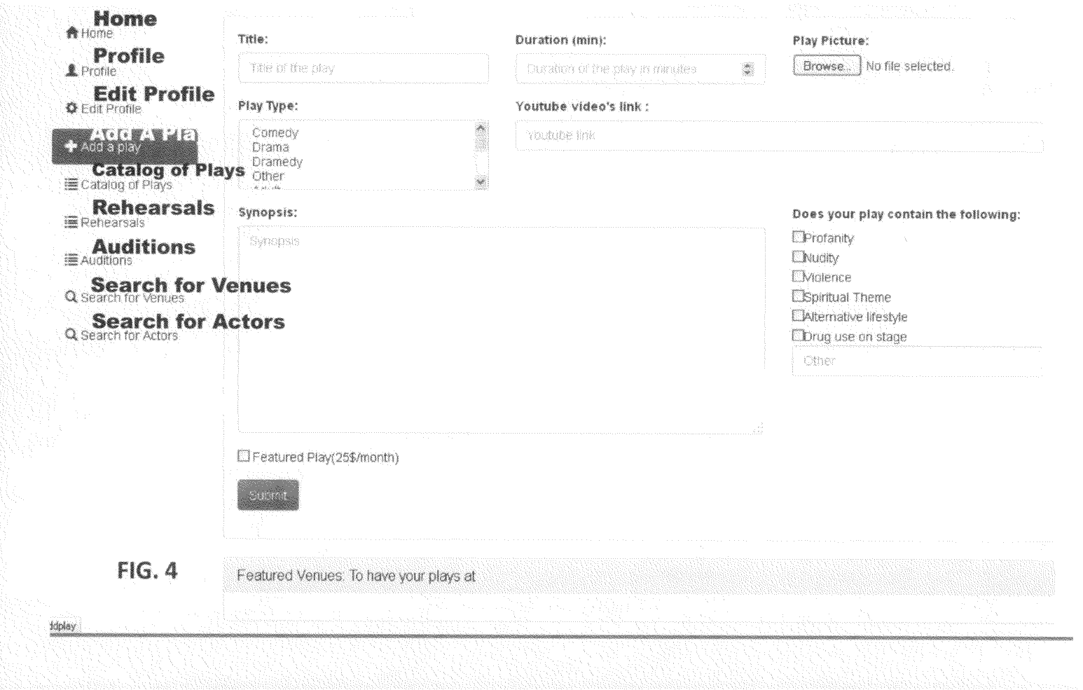

FIG. 4: In illustration is the Addition of a play for a playwright

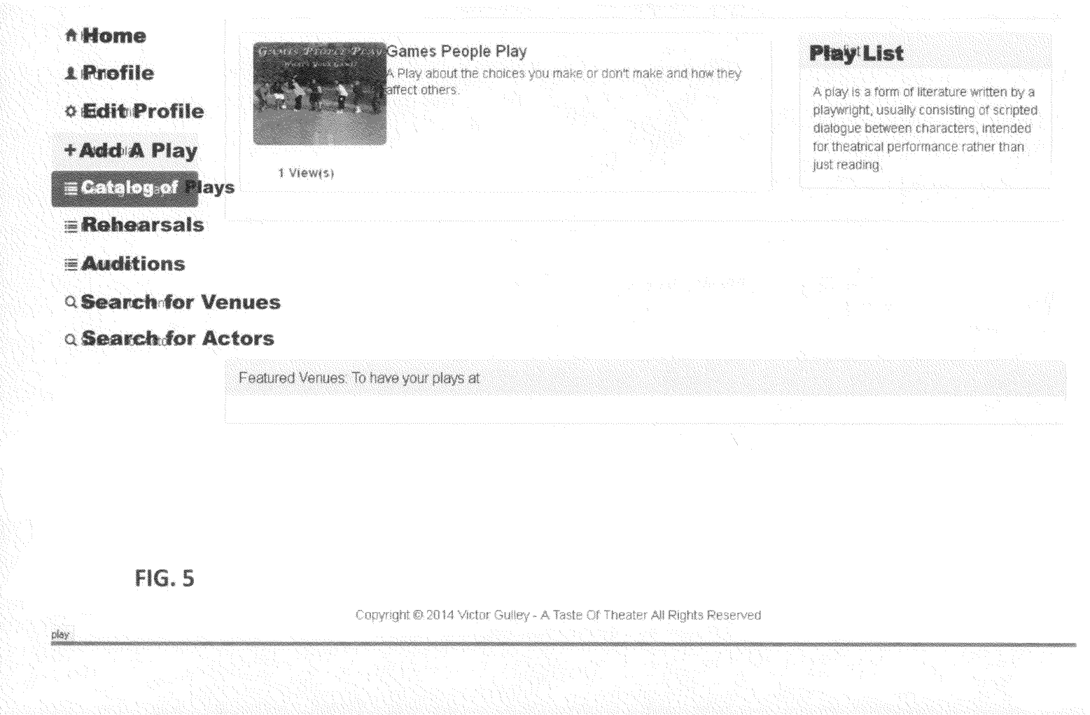

FIG. 5: In illustration is the list of the playwright's catalog of plays.

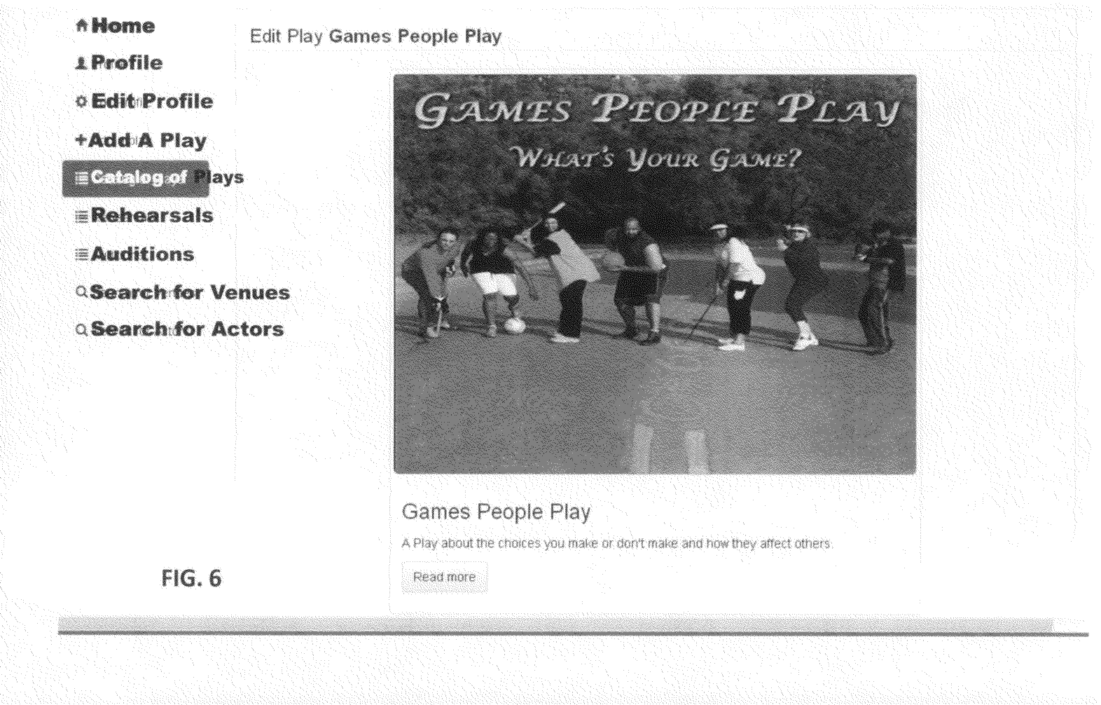

FIG. 6: In illustration is the modification of a playwrights play.

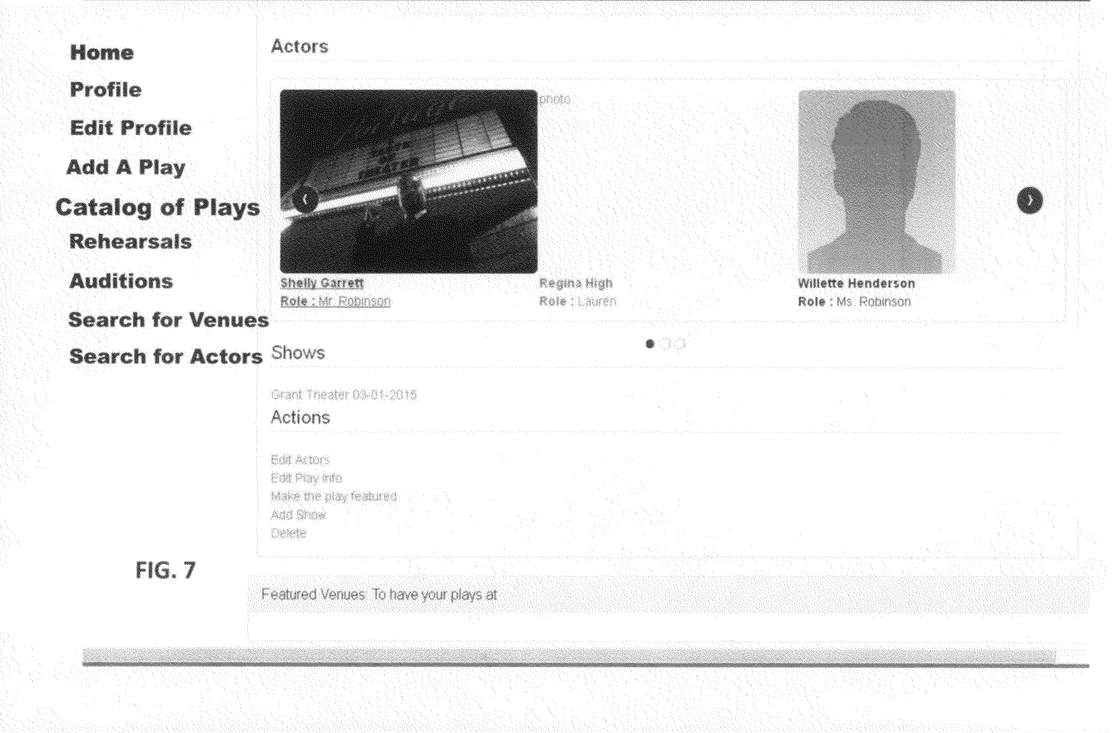

FIG. 7: In illustration is the list of Personnel or Actors staring in the playwrights play.

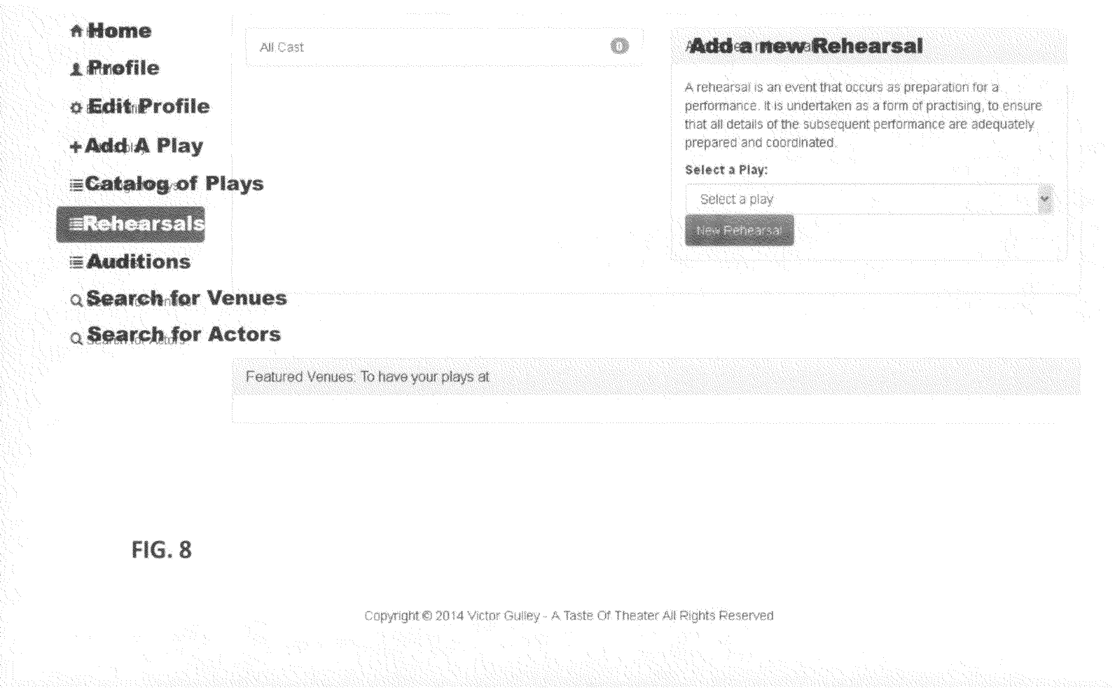

FIG. 8: In illustration is the list and creation of a rehearsal schedule for a playwrights play.

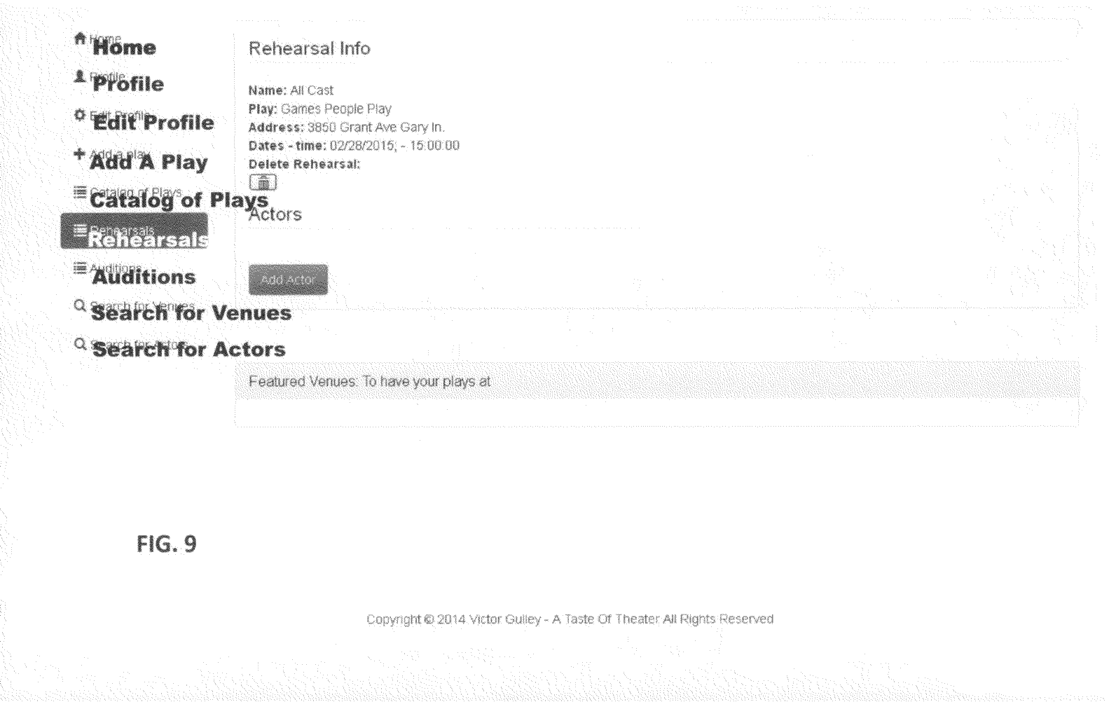

FIG. 9: In illustration is the actual rehearsal schedule a playwright created for personnel.

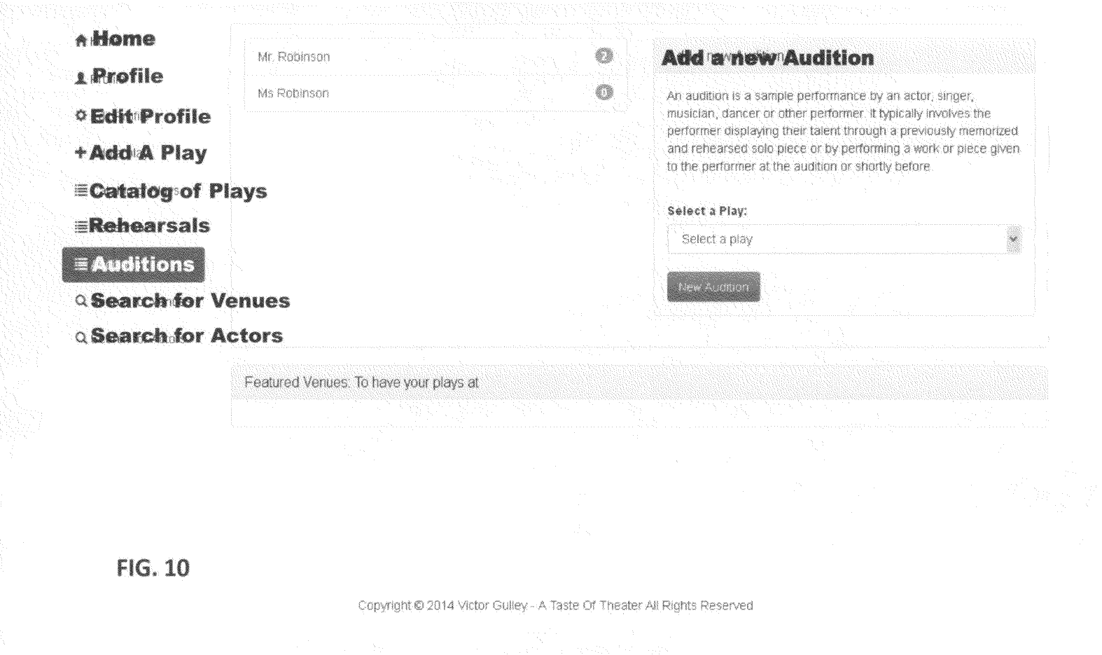

FIG. 10: In illustration is the list and creation of an audition schedule for a playwrights play.

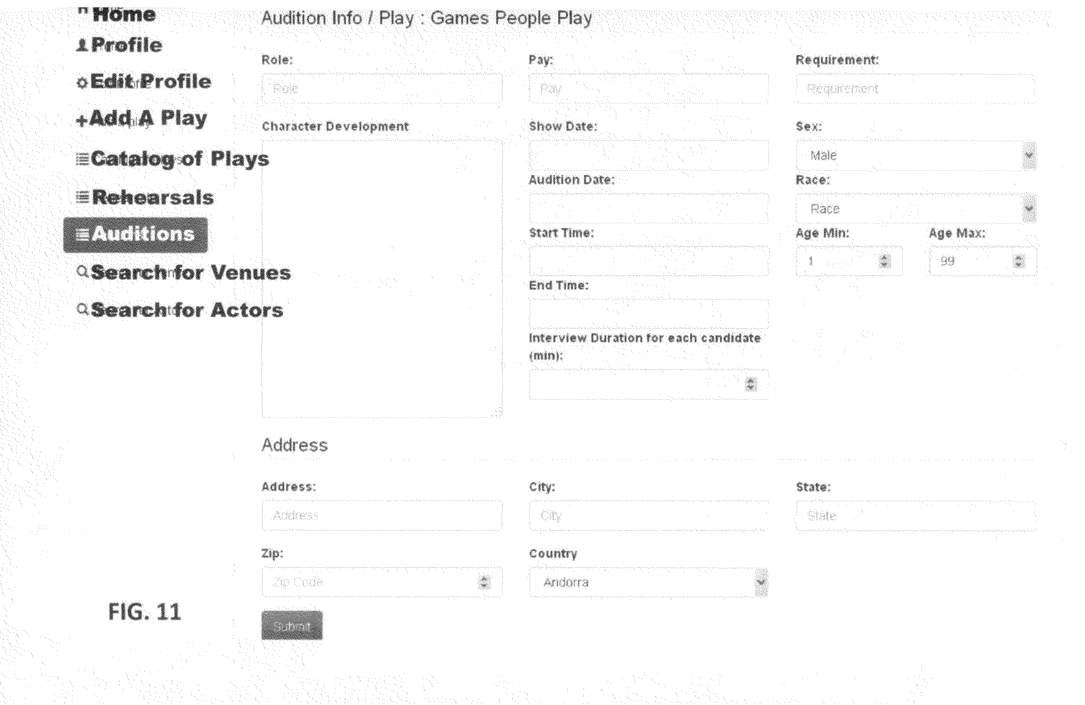

FIG. 11: In illustration are the fields required to create an audition schedule for a playwrights play.

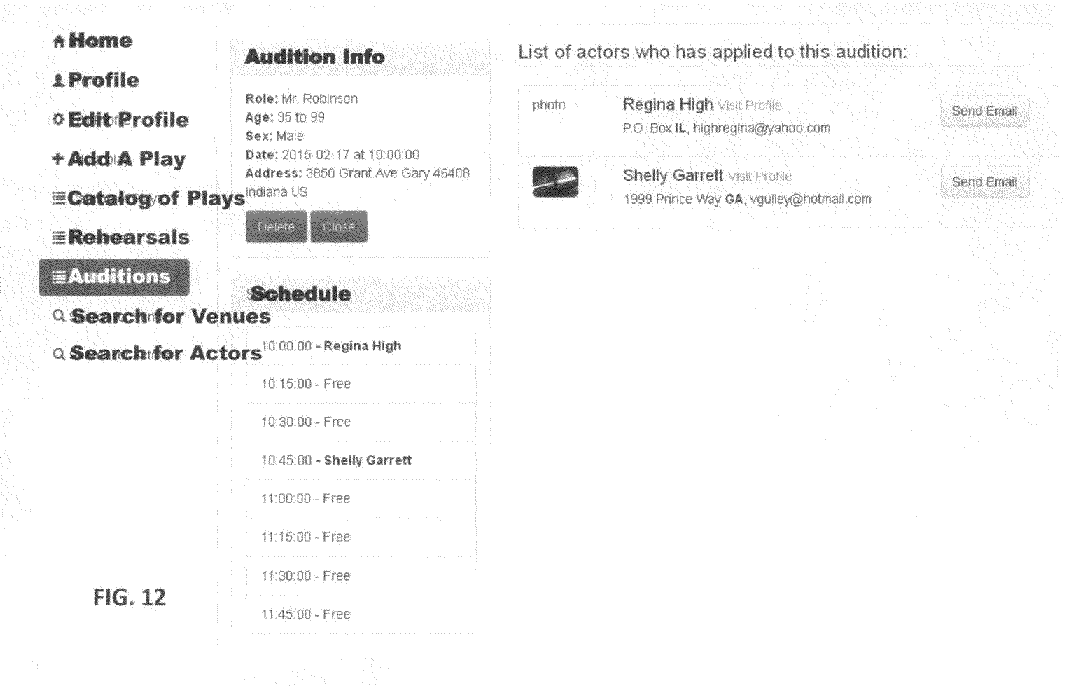

FIG. 12: In illustration is the result a playwright gets when actors have applied for an audition.

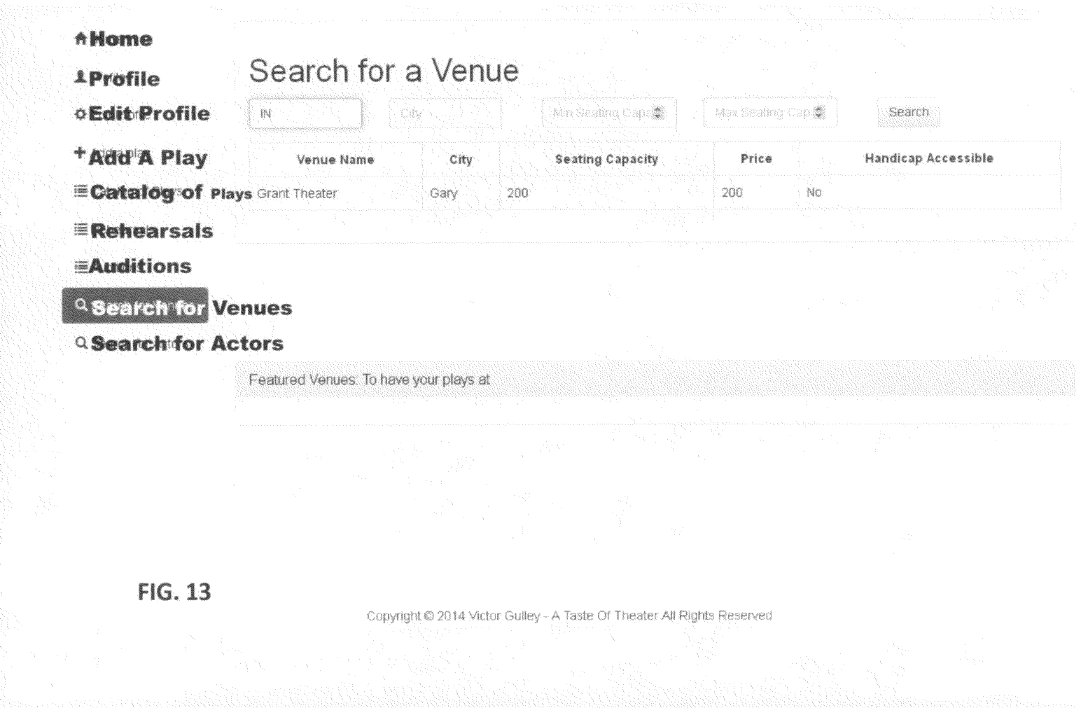

FIG. 13: In illustration is the query for a venue for a playwright to have his play at.

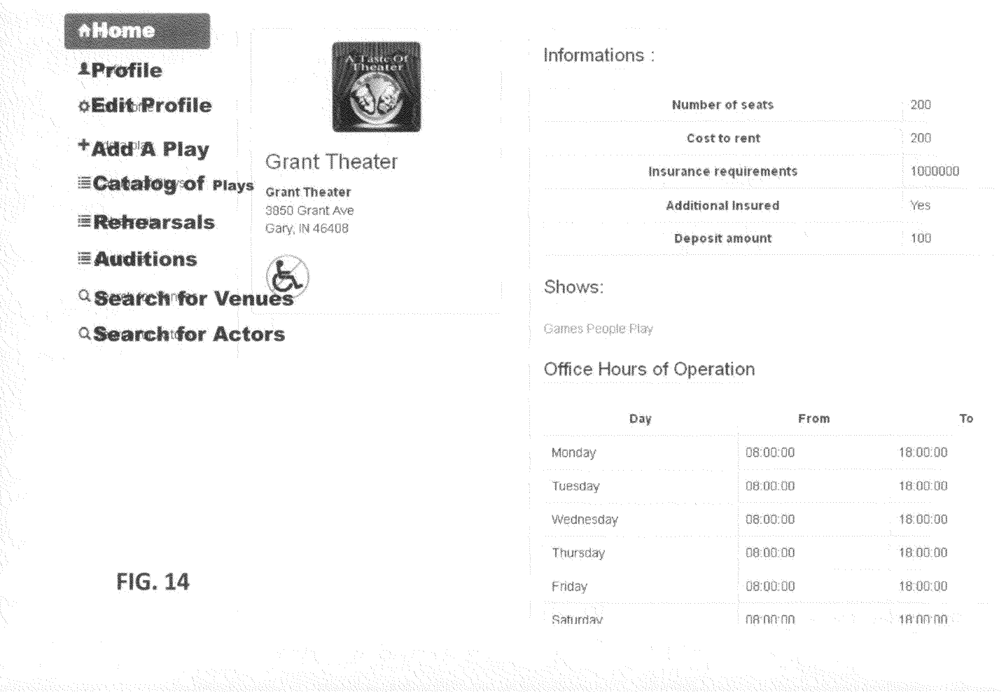

FIG. 14: In illustration is the result a query for a venue.

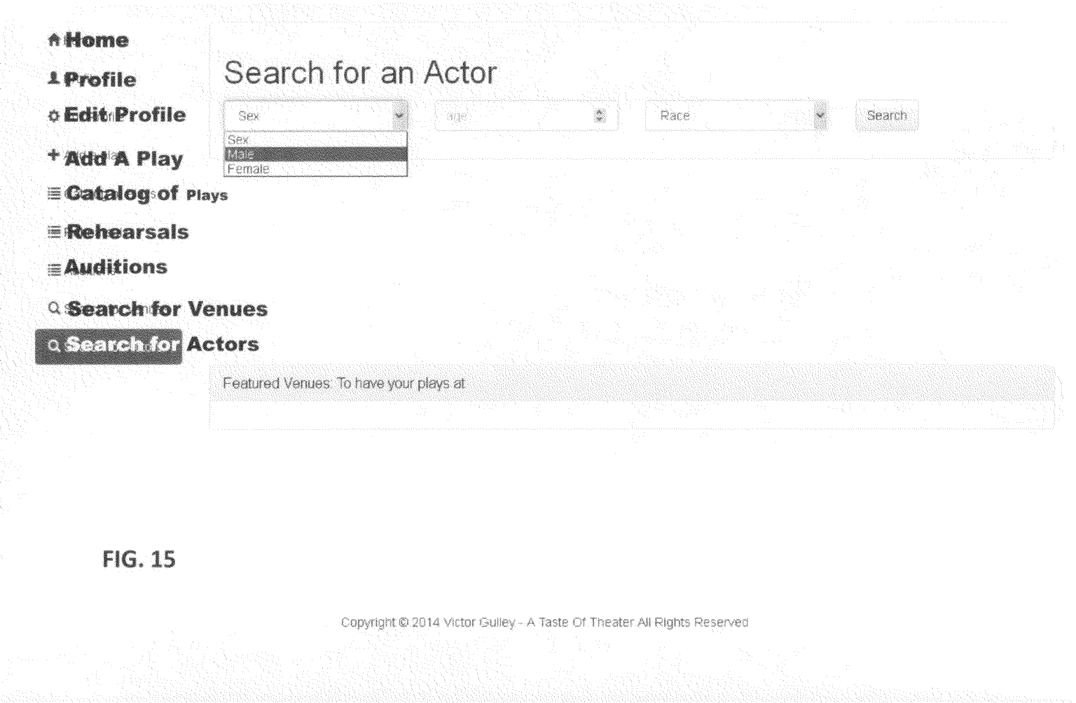

FIG. 15: In illustration is the query for an actor to star in your play.

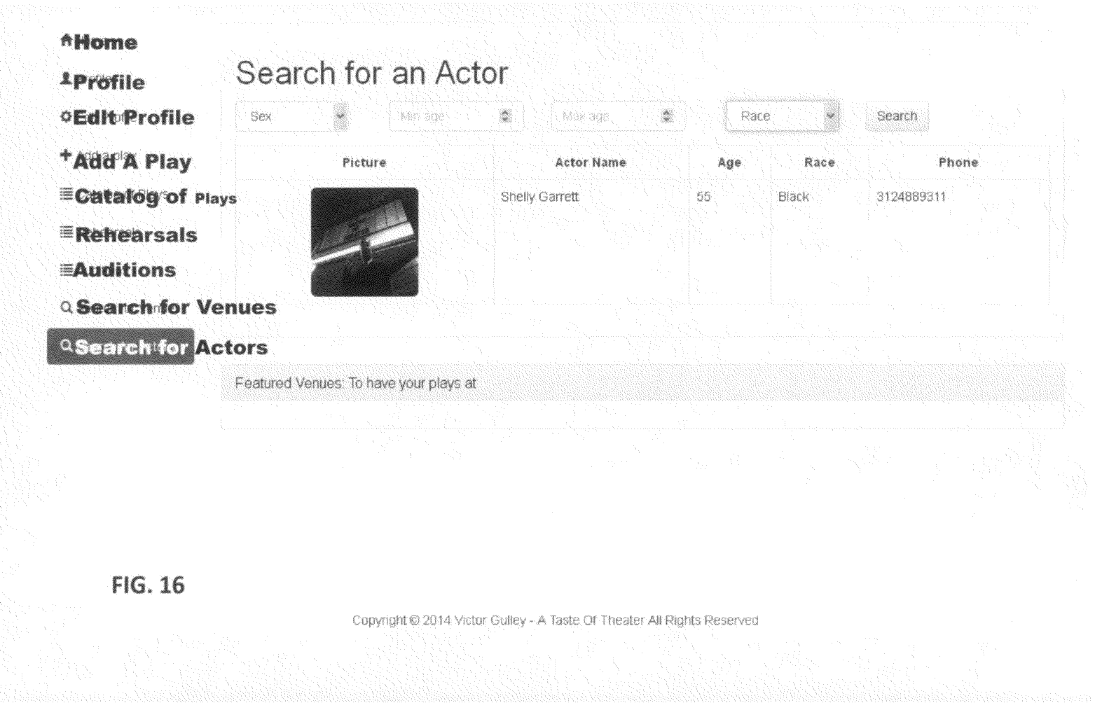

FIG. 16: In illustration are the results of a query for potential actors to star in your play.

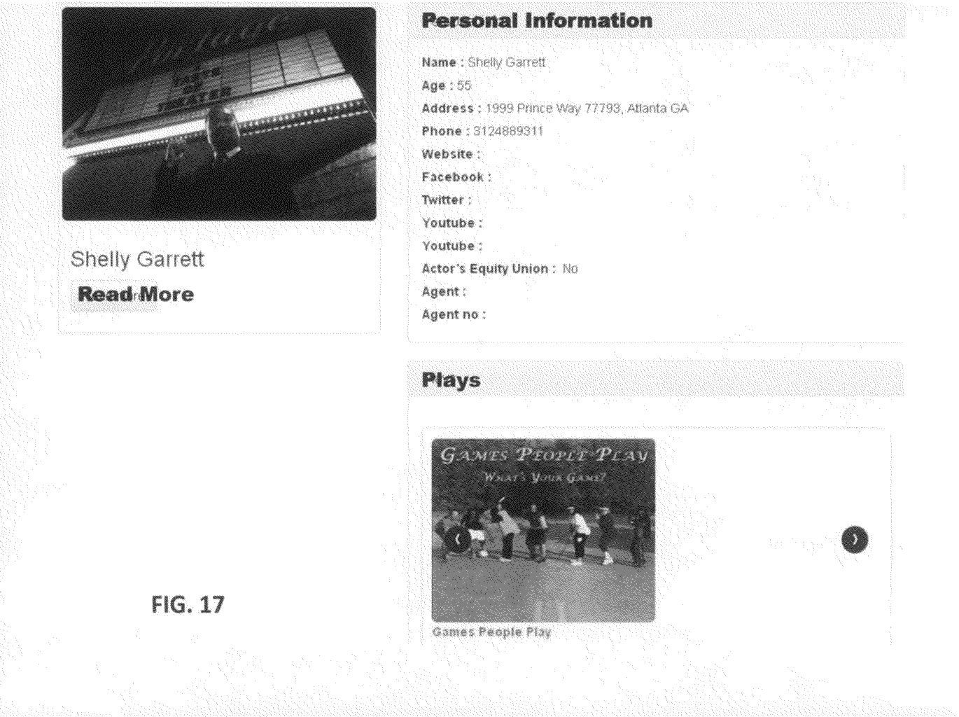

FIG. 17: In illustration is the actors profile and history of plays he or she has been in.

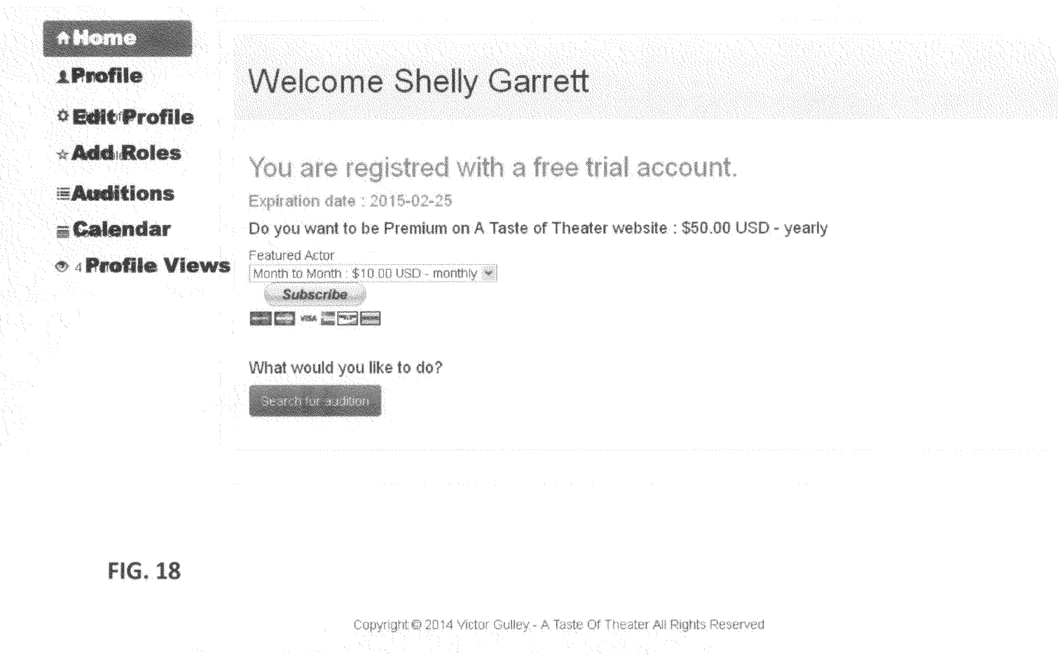

FIG. 18: In illustration is the log in screen for an actor.

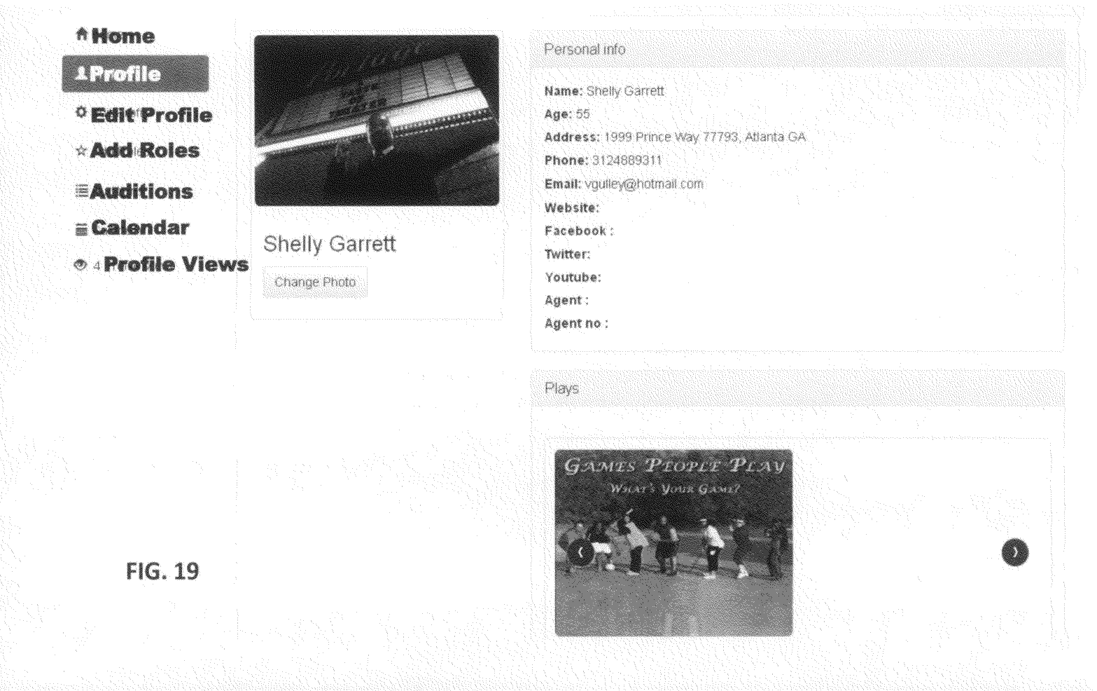

FIG. 19: In illustration is the profile of the registered actor.

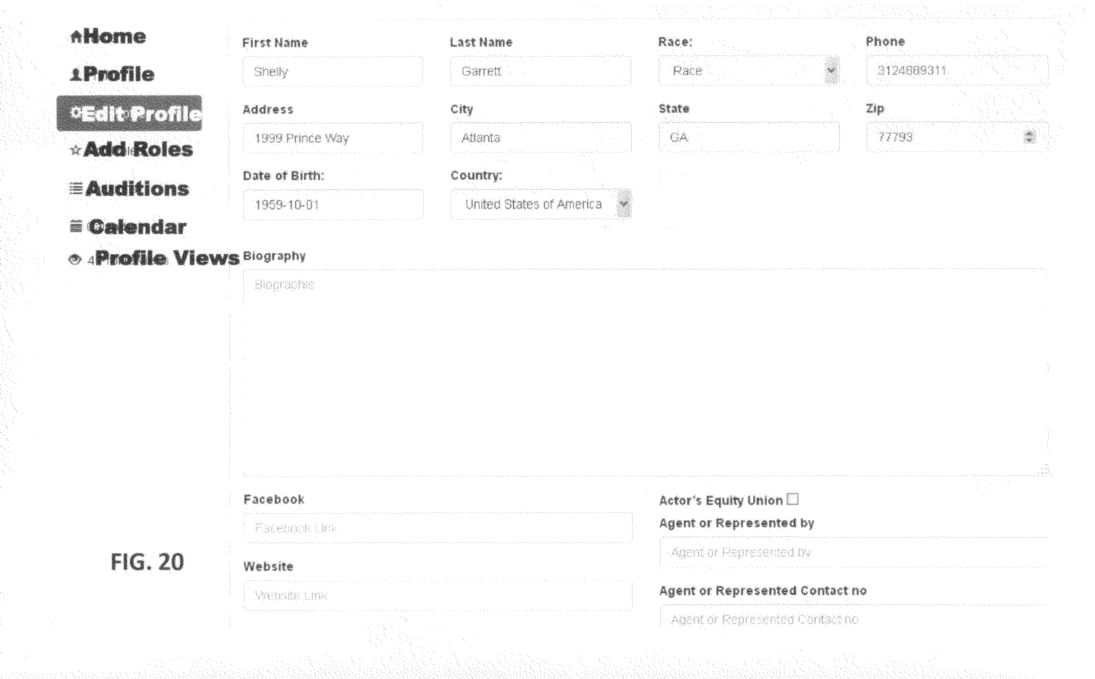

FIG. 20: In illustration is the actor's ability to modify his or her profile.

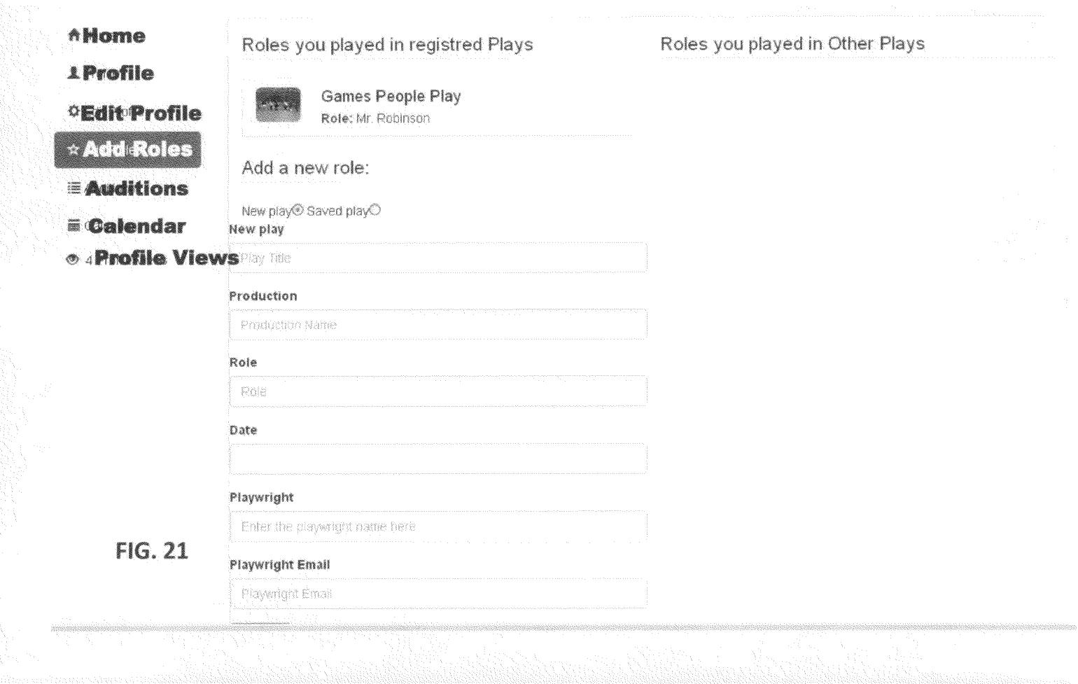

FIG. 21: In illustration is the actor's ability to add any plays that he or she was in that is currently not listed.

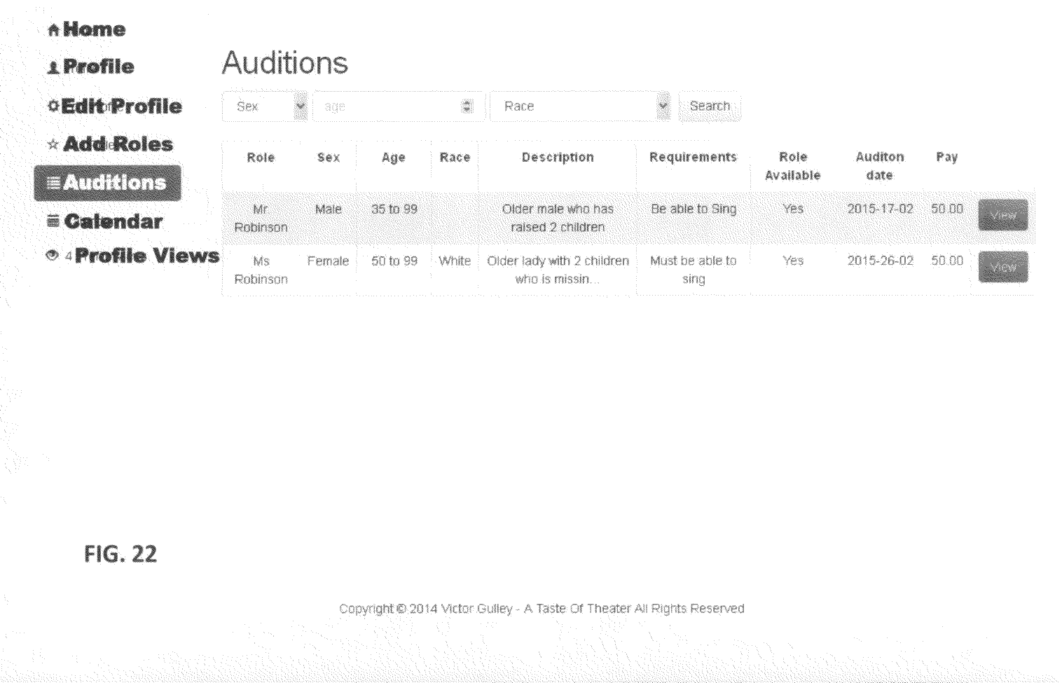

FIG. 22: In illustration is the actors query for possible auditions.

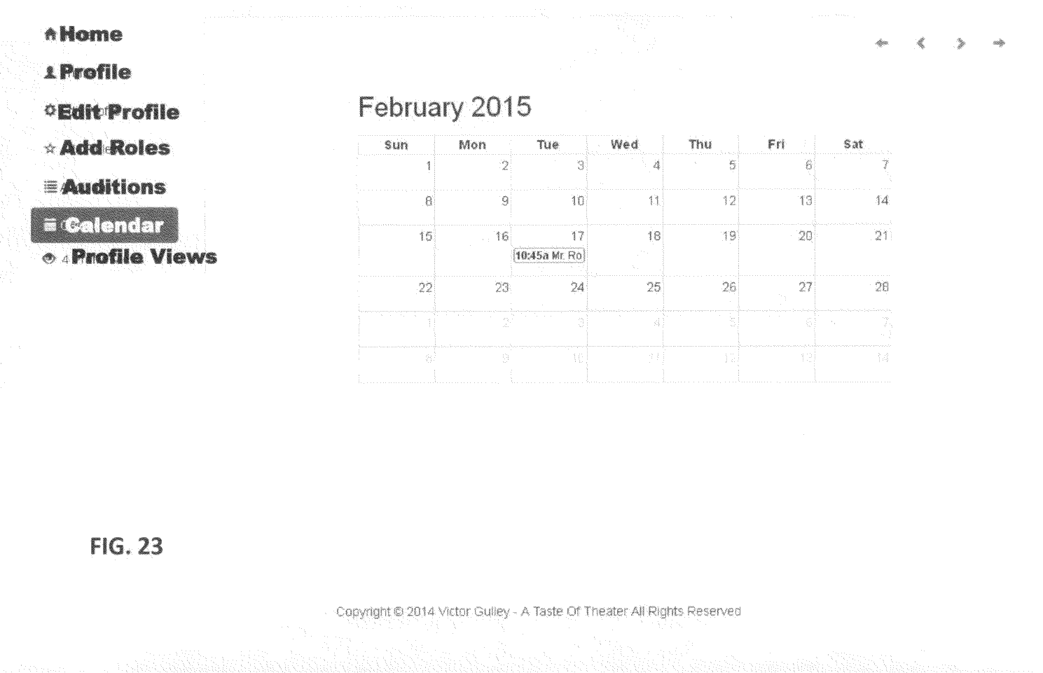

FIG. 23: In illustration is the actor's calendar showing current appointments.

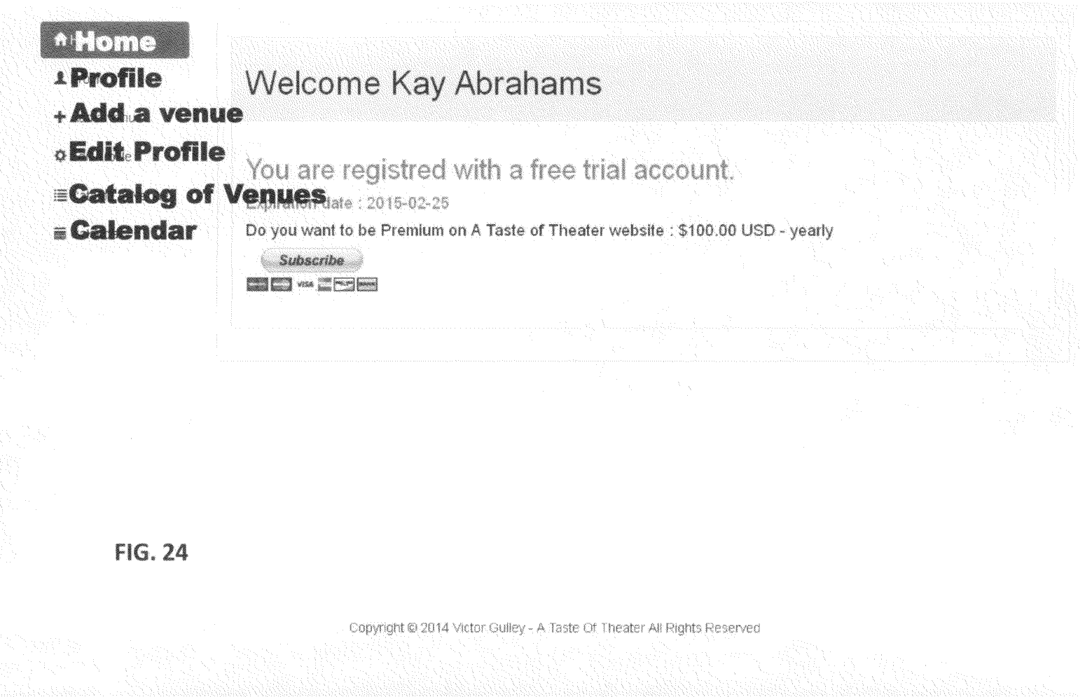

FIG. 24: In illustration is the log in screen for a venue owner.

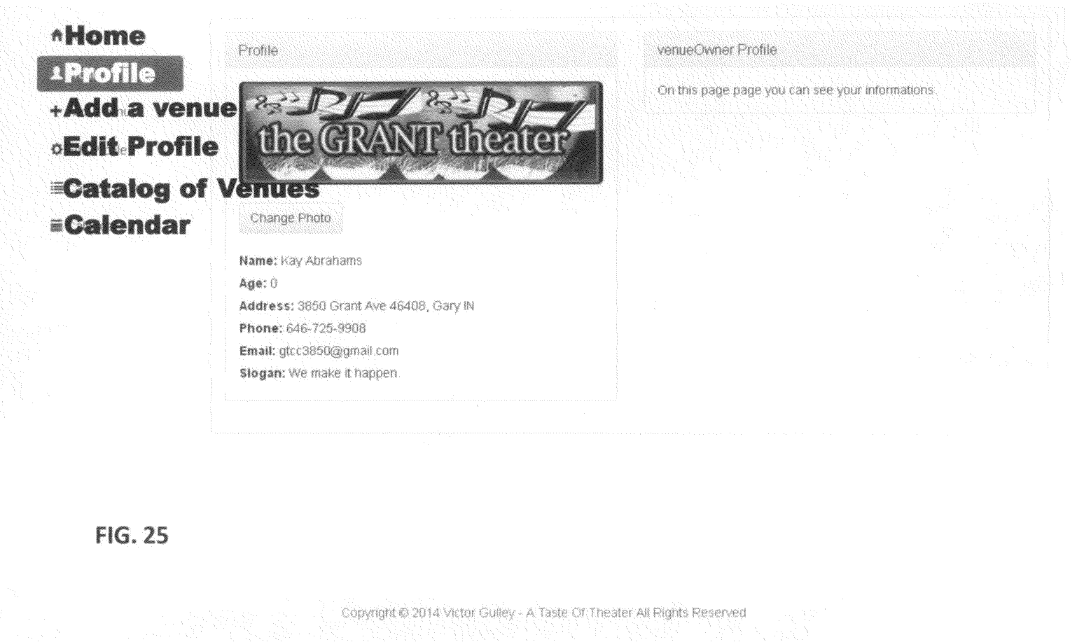

FIG. 25: In illustration is the profile screen for a venue owner.

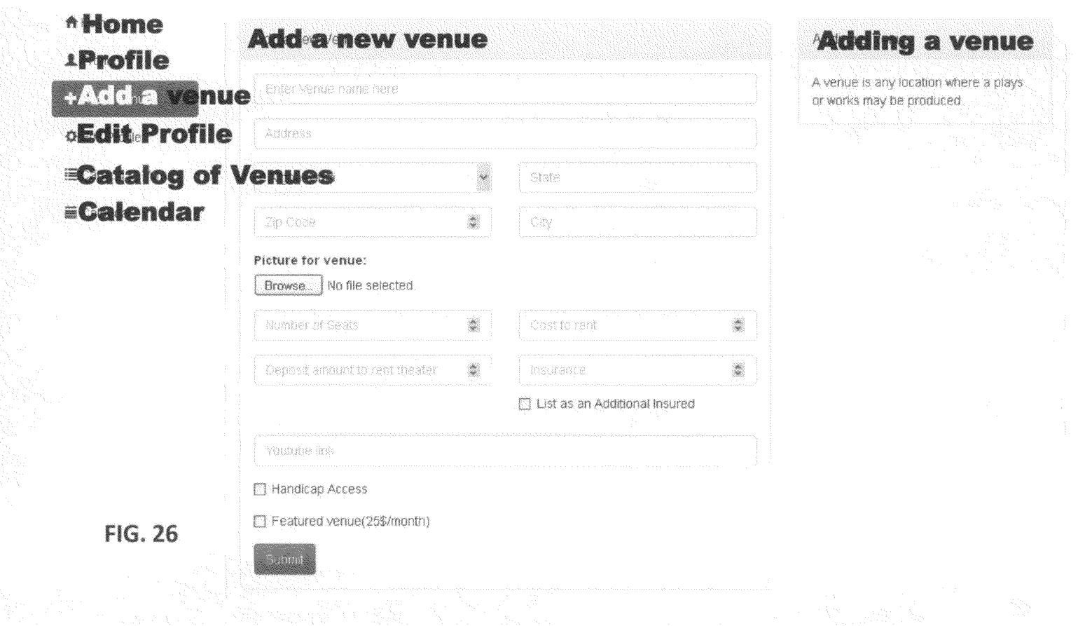

FIG. 26: In illustration allows the venue owner to add the details and cost of a venue.

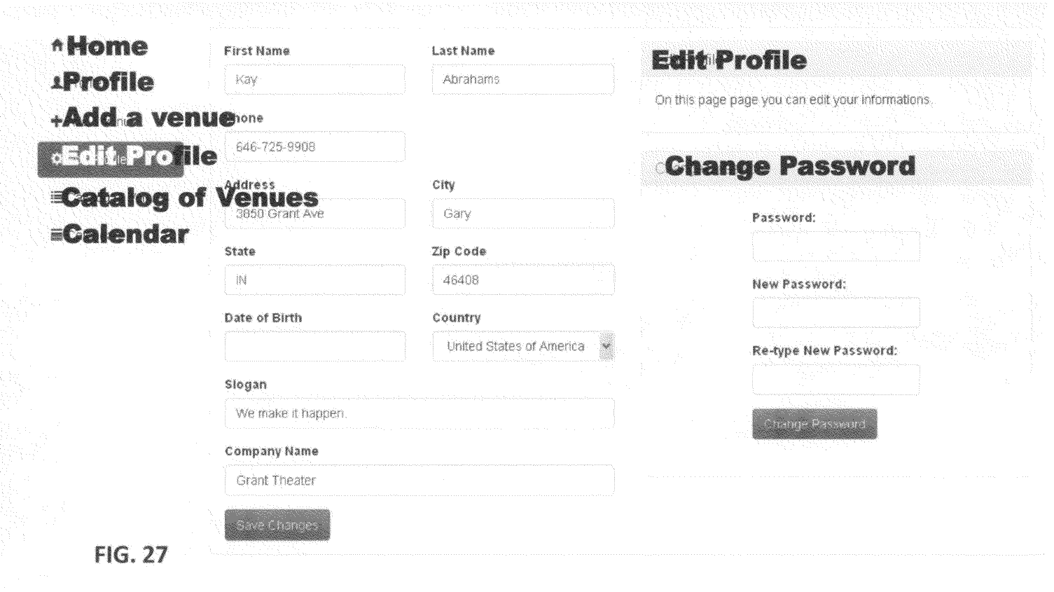

FIG. 27: In illustration allows the venue owner to make changes to his or her profile.

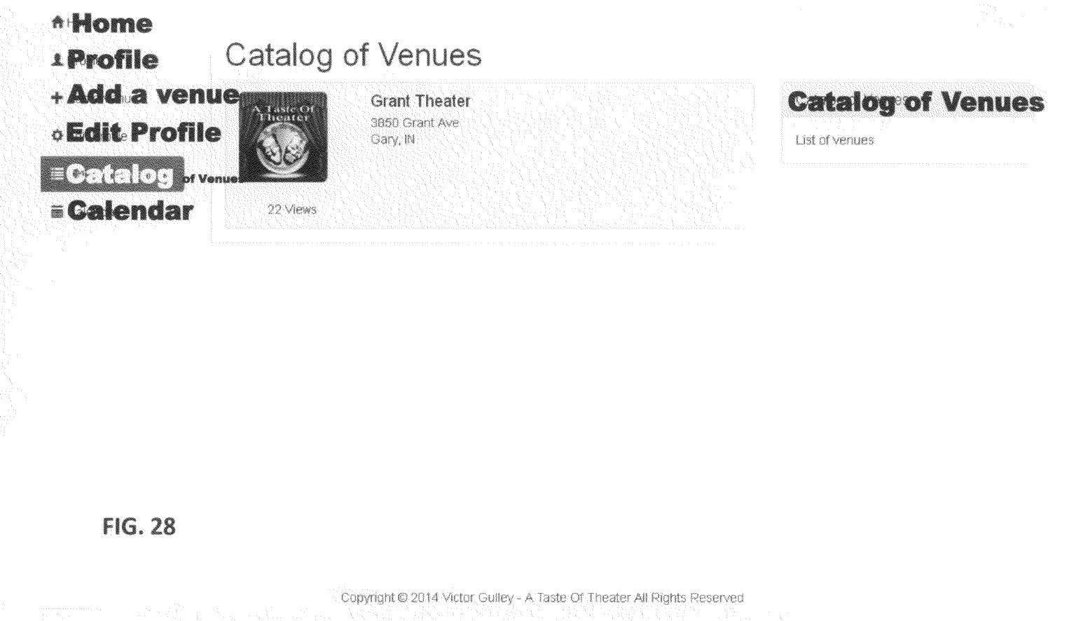

FIG. 28: In illustration is the catalog of all of the owner's venues

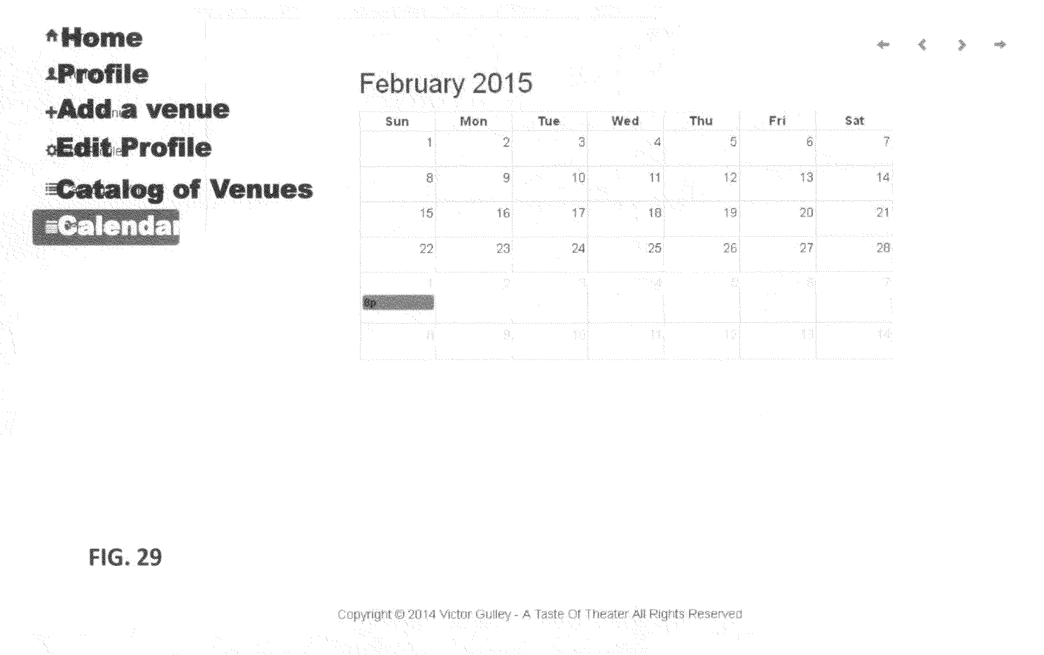

FIG. 29: In illustration is the venue owner's calendar of events.

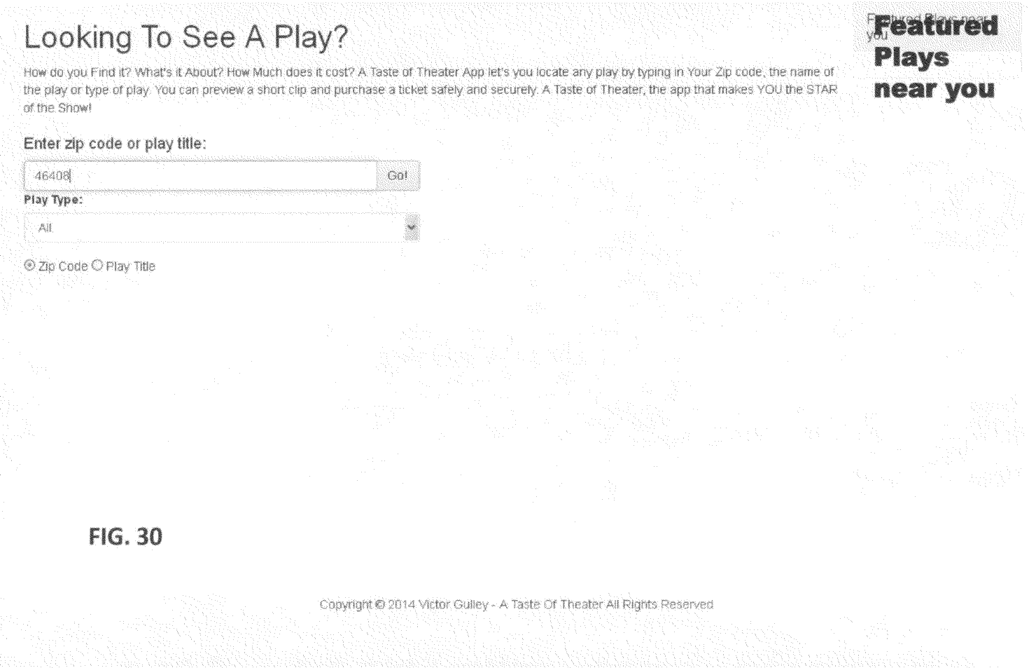

FIG. 30: In illustration is the theater goers search for a play by zip code.

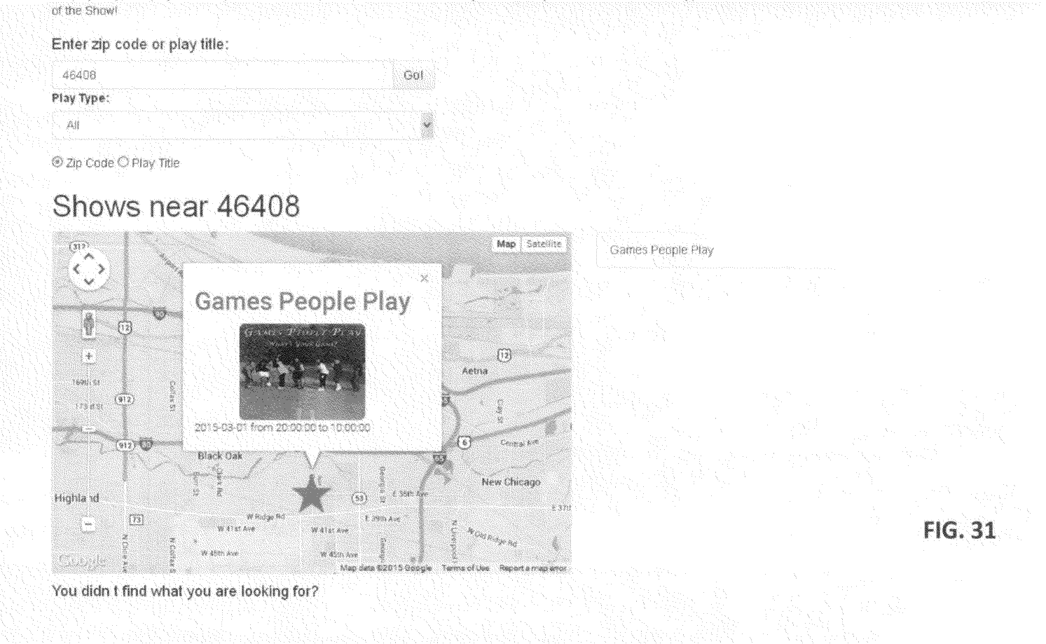

FIG. 31: In illustration is the result of plays available in that zip code.

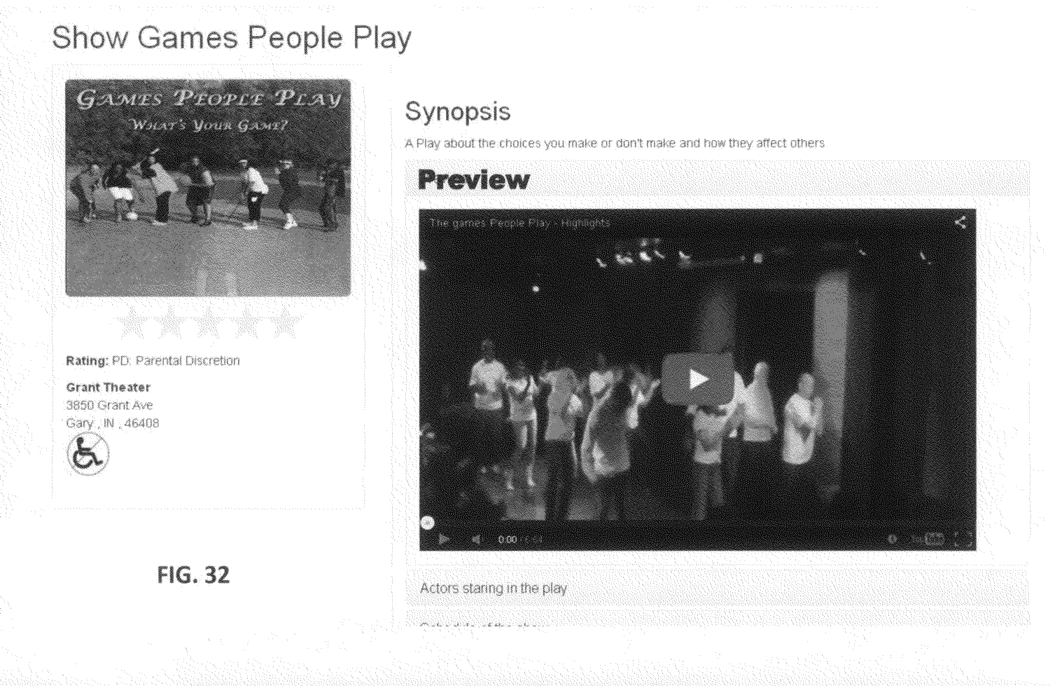

FIG. 32: In illustration are the details of the play in that zipcode including where, when and what it is about.

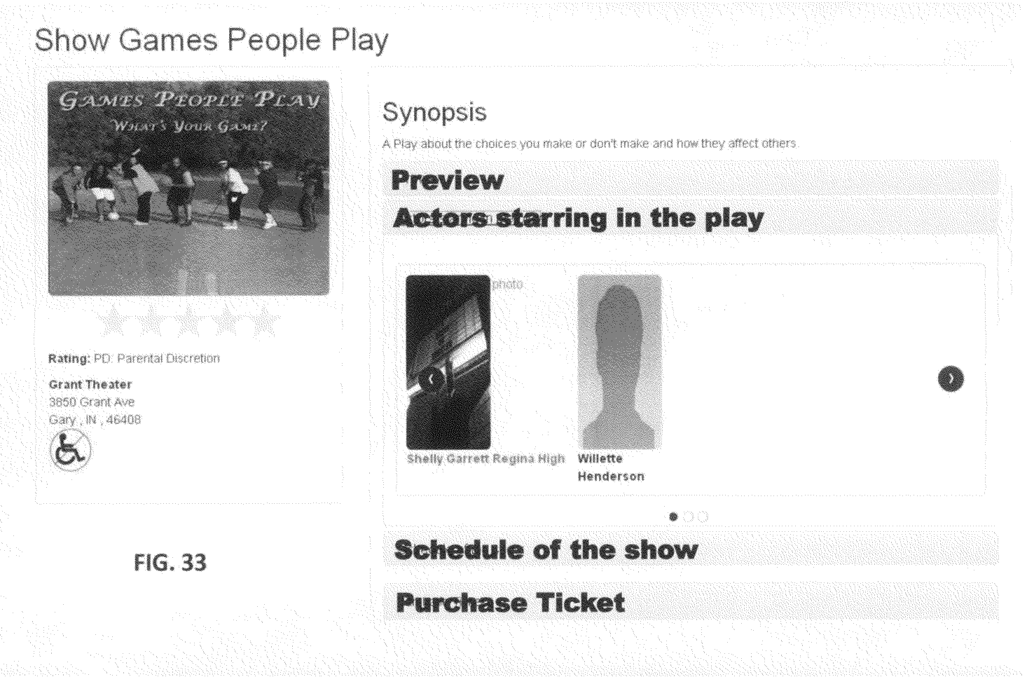

FIG. 33: In illustration are the details of the play in that zipcode including the actors who are in the show.

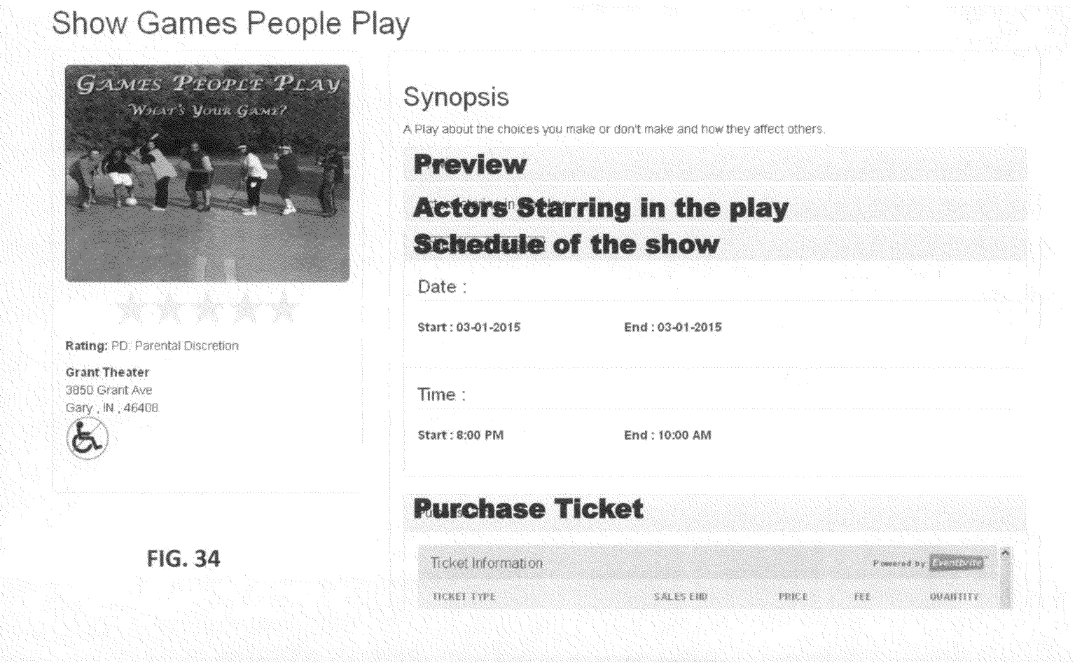

FIG. 34: In illustration are the details of the play in that zipcode include the day and time of the show.

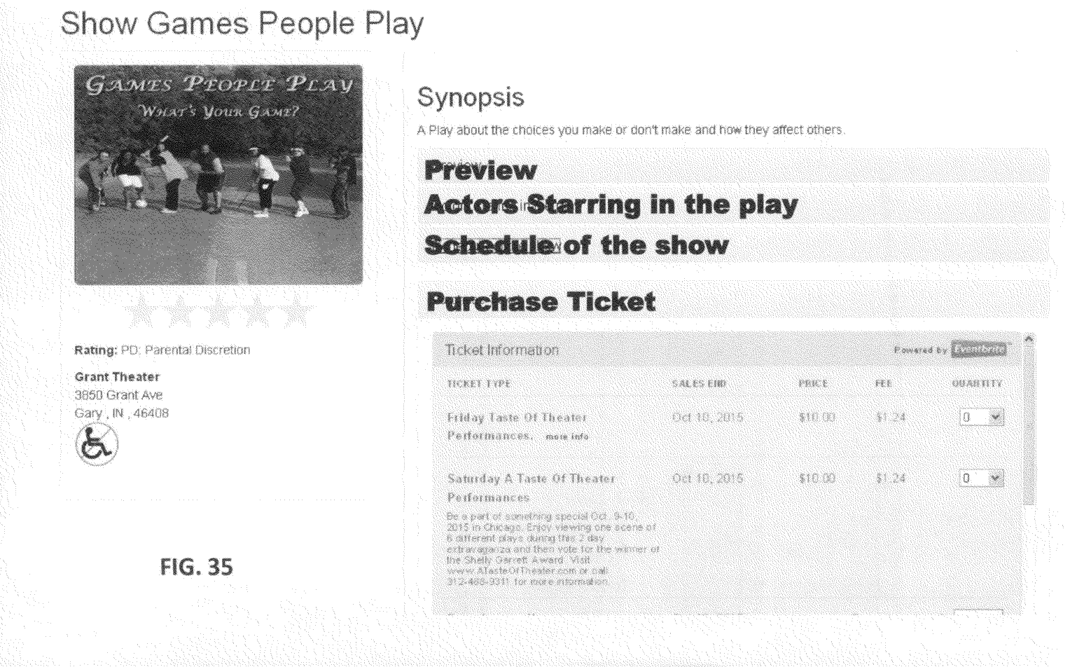

FIG. 35: In illustration are the details of the play in that zipcode including the ticket cost and ability to purchase.

### DETAILED DESCRIPTION OF THE INVENTION

In one aspect the “A Taste Of Theater App” allows playwrights to manage the process of doing a play. In other aspects the invention also allows Actors to manage their careers by utilizing one place to find auditions and their schedules. In a further aspect the invention also allows venue owners to rent their facility easier and more efficient for plays to be performed at that location. In an additional aspect the invention also allows theater goers to easily find and attend plays in their area.

One feature of the system is that the tangibly stored computer software, when executed, enables playwrights to use the software to log in and list all of the plays they have written to date with one or more images.

Another feature is that the software enables playwrights to use the software to log in and list all of the actors who starred in the play and the support staff who worked on the play.

A further feature is that the software enables playwrights to use the software to log in and list all auditions and manage how many audition spaces and for what roles they need.

A still further feature is that the software enables each playwright to use the software to separately log in and look for actors who meet specific criteria for a character to perform in their production.

An additional feature is that the software enables each playwright to use the software to log in and look for/search a place/venue to hold their play.

Another feature is that the software enables each actor to use the software to log in and look for plays to audition for and to apply.

Another feature is that the software enables each actor to use the software to log in to manage their bio, website, agent, and contact information.

Another feature is that the software enables each venue owner to use the software to log in to upload the name of the place for rent, pictures of the place to rent, video of the place to rent, the cost to rent the space, the insurance requirements to rent, the number of seats available to rent, the location of the place to rent, the deposit to rent and if the space is handicap-accessible or not. In this regard the software enables the venue owner to upload other requirements needed to rent the space.

Another feature is that the software enables each venue owner to use the software to log in and advertise their space for rent.

Another feature is that the software enables each actor to use the software to log in to advertise their acting abilities.

Another feature is that the software enables each playwright to use the software to log in and upload and stream their video-taped plays.

Another feature is that the software enables each playwright to use the software to log in and look for supplies, props, sound systems, mics for their production to rent or buy.

Another feature is that the software enables each playwright to use the software to log in to change their picture, their company name, their company slogan, their company image, their company address, and their phone number, email and birthdate.

Another feature is that the software enables each playwright to use the software to log in to utilize any ticketing software through the “Taste of Theater” software described herein.

Another feature is that the software enables each playwright to use the software to acquire a rating for each production based on the content of the play.

Another feature is that the software enables each theatre-goer to use the software to find a play by name, zip code, play type or by both together.

Another feature is that the software enables each theatre goer to use the software to watch a play via streaming over the interne or other medium on demand.

Another feature is that the software enables each theatre goer to use the software to add a review of each play or streaming play.

Another feature is that the software enables each theatre goer to use the software to share that they made a ticket purchase to play(s) in social media to their friends.

Another feature is that the software enables each theatre goer to use the software to save their plays to watch in a future playlist, saved watch list, already watched playlist, to stream over the internet.

What is claimed is:

1. A system according to claim 1, playwrights will utilize the software to log in and list all of their plays they have written to date with the image.

2. A system, according to claim 1, playwrights will utilize the software to log in and list all of the actors who starred in the play and the support staff who worked on the play.

3. A system according to claim 1, playwrights will utilize the software to log in and list all auditions and manage how many auditions spaces and for what roles they need.

4. A system according to claim 1, wherein each playwright will utilize the software to log in and look for actors who meet specific criteria for a character to perform in their production.

5. A system according to claim 1, wherein each playwright will utilize the software to log in and look for a place to hold their play.

6. A system according to claim 2, wherein each actor will utilize the software to log in and look for plays to audition for and apply.

7. A system according to claim 2, wherein each actor will utilize the software to log in to manage their bio, website, agent, and contact information.

8. A system according to claim 5, wherein each venue owner will utilize the software to log in to upload the name of the place for rent, pictures of the place to rent, video of the place to rent, the cost to rent the space, the insurance requirement to rent, the number of seats available to rent, the location of the place to rent, the deposit to rent and if the space is handicap accessible or not. Any other requirements needed to rent the space.

9. A system according to claim 5, wherein each venue owner will utilize the software to log in and advertise their space for rent.

10. A system according to claim 2, wherein each actor will utilize the software to log in to advertise their acting abilities.

11. A system according to claim 1, wherein each playwright will utilize the software to log in and upload and stream their video-taped plays.

12. A system according to claim 1, wherein each playwright will utilize the software to log in and look for supplies, props, sound systems, mics for their production to rent or buy.

13. A system according to claim 1, wherein each playwright will utilize the software to log in to change their picture, their company name, their company slogan, their company image, their company address, and their phone number, email and birthdate.

14. A system according to claim 1, wherein each playwright will utilize the software to log in to utilize any ticketing software through our software.

15. A system according to claim 1, wherein each playwright will utilize the software to acquire a rating for each production based on the content of the play.

16. A system according to claim 16 wherein each theatre goer will use the software to find a play by name, zip code, play type or by both together.

17. A system according to claim 16, wherein each theatre goer will use the software to watch a play via streaming over the internet or other medium on demand.

18. A system according to claim 16, wherein each theatre goer will use the software to add a review of each play or streaming play.

19. A system according to claim 16, wherein each theatre goer will use the software to share that they made a ticket purchase to play(s) play a in social media to their friends.

20. A system according to claim 16, wherein each theatre goer will use the software to save their plays to watch in a future playlist, saved watch list, already watched playlist, to stream over the internet.

21. A system according to claim 5, wherein each actor will log into the software and manage what type of email notifications he or she will receive for auditions based on specific criteria, sex, race and age.

22. A system according to claim 16, wherein each theatre goer will use the software to manage their emails to determine what type of plays they should go see or stream based on specific criteria, drama's, comedy, alternative, spiritual, zip code, state, city, rating, playwright, and actors.

23. A system according to claim wherein each playwright can license another's play and pay a fee to perform it.

24. A system according to claim wherein Professional Organizations around the theatre life can list what they are and what they do and accept membership.
